(19) United States
(12) Patent Application Publication
(10) Pub. No.: US 2012/0003363 A1
(43) Pub. Date: Jan. 5, 2012

(54) EDIBLE BREAD CUP AND METHOD OF PRODUCTION

(76) Inventor: Arthur L. Beloff, Palm Beach, FL (US)

(21) Appl. No.: 13/167,266

(22) Filed: Jun. 23, 2011

Related U.S. Application Data
(60) Provisional application No. 61/398,887, filed on Jul. 3, 2010.

(51) Int. Cl. A21D 13/00; A23P 1/14

(52) U.S. Cl. 426/138; 426/446

(57) ABSTRACT

An edible bread cup and an apparatus and method for making edible bread cups is disclosed. The apparatus for molding and baking dough into an edible cup has a top and a bottom molding sheet. The bottom molding sheet has several cup-shaped female molds for receiving several identically shaped male molds built into the top molding sheet. Dough is flattened into patties and is rested in the female molds, after which the male molds are lowered into the female molds, thereby shaping the dough to the cup-shape of the molds. Guiding rods on the top sheet slide into guiding tubes on the bottom sheet in order to align the sheets before the molds come into contact. After the sheets are brought together, clamps are secured around the edges of the sheets to hold the sheets together. The dough is baked while between the sheets, which causes the dough to rise and fill the cup-shaped void between the molds. Air is pressed out of this void, either through air release pinholes or through canal grooves built into the top and bottom sheets. After the baking is complete, the clamps are removed and the sheets are separated, after which the finished bread cups may be removed for packaging.

This non-provisional application is based on provisional patent application Ser. No. 61/398,887 filed on Jul. 3, 2010.

### BACKGROUND OF THE INVENTION

1. Field of the Invention

The present invention relates to an edible bead cup and an apparatus and method for molding and baking dough to produce an edible bread cup.

2. Discussion of the Related Art

There is an increasing demand for convenient food items, i.e. food which can be quickly prepared and easily consumed. One of the most common disadvantages of conventional bread products used to make sandwiches, and other food products is that they are often messy to eat, particularly while travelling where only one hand is available, e.g. while driving. The most common fast food choices such as sandwiches, rolls, wraps, pitas etc. allow food to spill out while eating with only one hand. A cleaner alternative to these options is a cup-shaped piece of bread which may be filled with any type of food (e.g. meats, vegetables, fruits, desserts). Current available methods for baking a bread cup are not well known and do not create a strong, consistent product. As a result, bread cups have not become a popular item for purchase. Therefore, there remains a need for a better method of manufacturing bread cups.

### OBJECTS AND ADVANTAGES OF THE INVENTION

Considering the foregoing, it is a primary object of the present invention to provide an apparatus and method of using the apparatus for manufacturing a cup-shaped bread vessel.

It is a further object of the present invention to provide an apparatus and method of using the apparatus for manufacturing a cup-shaped bread vessel which may be formed of any type of baked edible substance such as white bread, whole wheat bread, rye bread, sourdough bread, dessert breads, waffle, etc.

It is a further object of the present invention to provide an apparatus and method of using the apparatus for manufacturing a cup-shaped bread vessel, as described above, which may be of any size and shape.

It is a further object of the present invention to provide an apparatus and method of using the apparatus for manufacturing a cup-shaped bread vessel, as described above, which may contain any variety or combination of edible substances such as meats, cheeses, vegetables, fruits, salads, soups, desserts etc.

It is a further object of the present invention to provide an apparatus and method of using the apparatus for manufacturing a cup-shaped bread vessel, as described above, which may have patterns or indicia shaped into the molds for forming onto the baked cups (e.g. restaurant logos, waffle patterns etc.)

It is a further object of the present invention to provide a cup-shaped bread vessel which provides a cleaner method of eating foods while travelling and/or while only using one hand.

It is a further object of the present invention to provide an edible bread cup which is cheap and easy to produce in high quantities.

These and other objects and advantages of the present invention are more readily apparent with reference to the detailed description and accompanying drawings.

### SUMMARY OF THE INVENTION

The terms “bread” and “dough” as used herein are meant to include a variety of edible substances made from dough such as white bread, whole wheat bread, sourdough bread, dessert breads etc. The generic terms “bread” and “dough” are therefore only used for convenience and is not meant in any way to limit the scope of the invention.

The term “cup” as used herein is meant to include any vessels having a variety of sizes and shapes which are capable of receiving a volume of food and/or liquid. Unless otherwise specifically mentioned herein, the term “cup” is simply used for convenience and does not limit the scope of the invention.

Disclosed is an apparatus and method for using the apparatus for baking a bread cup. Dough is rolled into patties of a selected size and shape using conventional methods. The appended drawings illustrate a circular patty design; however any shape and size may be used. The flattened dough patties are then received by female cup-shaped molds on a lower mold plate. Identically shaped male molds on an upper mold plate are then lowered into the female molds, evenly flattening and spreading the dough upward between the molds.

Hollow cylindrical guiding tubes extend downward from the bottom side of the bottom plate. Guiding rods extend downward from the bottom side of the top plate. The guiding tubes of the bottom mold plate are meant to receive the guiding rods of the top mold plate inserted from above, thereby ensuring that all of the molds are precisely and accurately inserted and received. The guiding tubes and rods make contact well before the molds do so thereby ensuring that alignment is already achieved before the molds reach each other.

In one preferred embodiment, several air release pinholes are located along the tops of the female molds. When the dough initially spreads as the molds are brought into contact, it does not fill the entire void between the molds. However, as it is baked it will expand upwardly, thereby pressuring the air upwards between the molds. These air release pinholes will allow this air to escape. The pinholes of this embodiment are located below the bottom plate.

In a second preferred embodiment, air escapes from the space between the molds through canal grooves formed along the top and bottom plates. Semi-cylindrical grooves are formed into the top and bottom plates so that when the plates are brought together and attached, they form cylindrical grooves which connect to all of the molds and to the outer edges of the plates. Air is then able to escape from the molds through these canal grooves to the outer edges of the plates.

When the molds are brought together with the dough between them, clamps are secured to the plates in order to hold the upper and bottom plates together. These clamps are tightened so that during the baking, the increased pressure within the spacing between the molds does not force the plates to separate.

In a preferred embodiment of the present invention, the molds may be modified to provide a ridge at the upper portion. This gives the finished bread cup a ridge at its opening (well known in the art of drinking vessels) and more importantly provides a means for suspending the dough in the female mold prior to the male mold being inserted, helping to ensure an even spread of dough along the mold.

The bread cup is meant to hold any variety of edible substances such as meat, cheese, vegetables, fruits, soup, salads, dessert items etc. The cup may be formed by any edible substance which is baked (e.g. white bread, rye bread, dessert breads, waffle, etc.). The cup may be of any practical size or shape.

### BRIEF DESCRIPTION OF THE DRAWINGS

For a fuller understanding of the nature of the present invention, reference should be made to the following detailed description taken in conjunction with the accompanying drawings in which:

FIG. 1 is a perspective view of a first embodiment of the present invention illustrating a top molding plate and a bottom plate having male and female molds, respectively, and canal grooves built into the plates.

FIG. 2 is a side elevational view of the first embodiment of the present invention as shown in FIG. 1.

FIG. 3 is a cross sectional view of the first embodiment of the present invention taken along A-A as shown in FIG. 1 after the two molding plates have been brought together with dough in the molds.

FIG. 4 is a side elevational view of the first embodiment of the present invention showing the dough resting on the ridges of the female molds.

FIG. 5 is a cross sectional view of a second embodiment of the present invention taken along A-A which has air release pinholes instead of canal grooves.

FIG. 6 is an isolated cross sectional view taken from FIG. 5.

Like reference numerals refer to like parts throughout the several views of the drawings.

### DETAILED DESCRIPTION OF THE PREFERRED EMBODIMENT

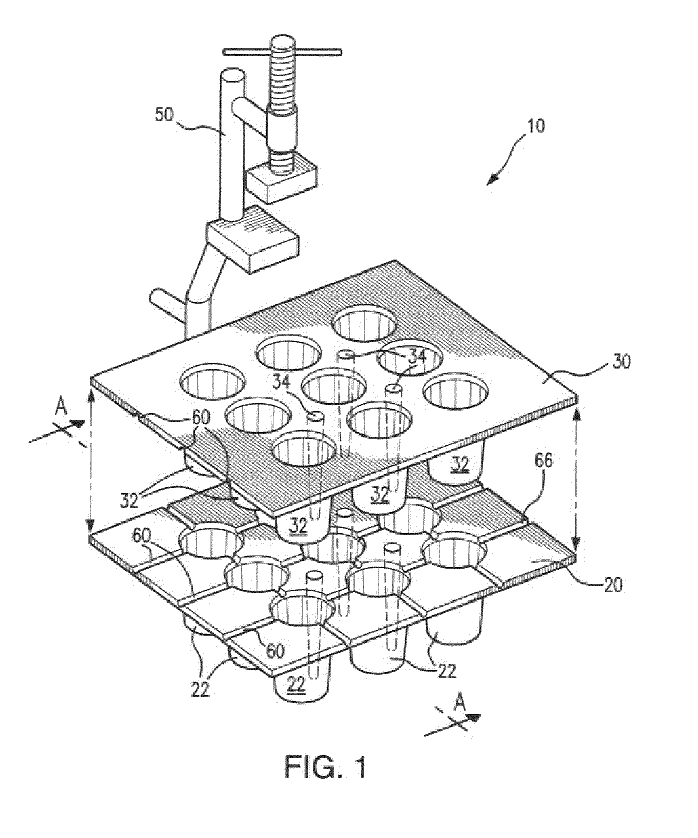

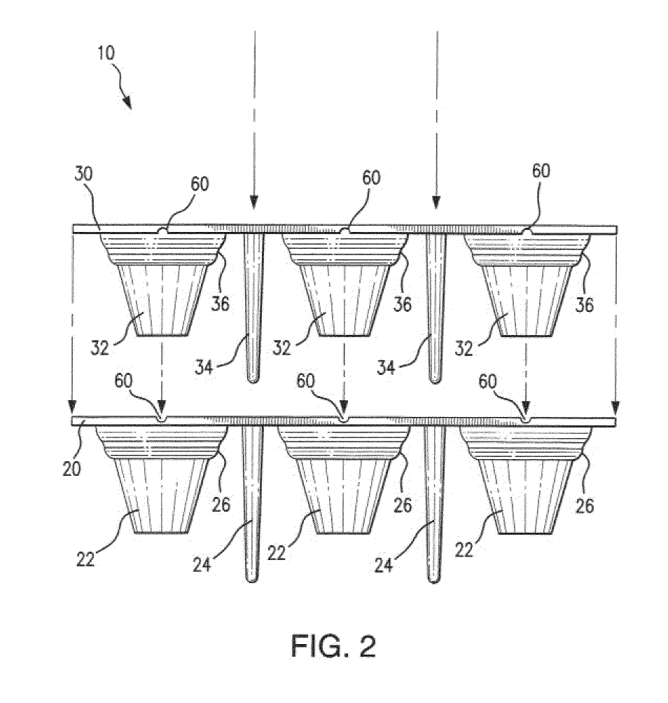

Referring to FIGS. 1-6, the apparatus for molding and baking a dough cup is shown and is generally indicated as 10.

A bottom molding sheet 20 contains a number of bottom-facing female molds 22. A top molding sheet 30 contains a number of bottom-facing male molds 32. Male molds 32 fit into female molds 22 when the top sheet 30 is lowered towards and into engagement with the bottom sheet 20. Female molds 22 and/or male molds 32 may include printed or indicia (e.g. logos, waffle pattern etc.) to be formed onto the dough cup.

Bottom sheet guiding tubes 24 and correspondingly aligned top sheet guiding rods 34 extend downwardly from the bottom sheet 20 and top sheet 30, respectively. The top sheet guiding rods 34 are aligned directly over the bottom sheet guiding tubes 24 and fit into them when the top sheet 30 is lowered onto the bottom sheet 20. Guiding tubes 24 and rods 34 are significantly longer than the molds 22 and 32 to ensure that proper alignment of the top sheet 30 and bottom sheet 20 is achieved before the molds 22 and 32 come into contact.

In a preferred embodiment, female mold 22 includes an annular ridge 26 and male mold 32 includes an annular ridge 36. Creating a ridge in a cup-shaped vessel is well known in the art and is also helpful for securing the dough 40 to the female mold 22 as described below.

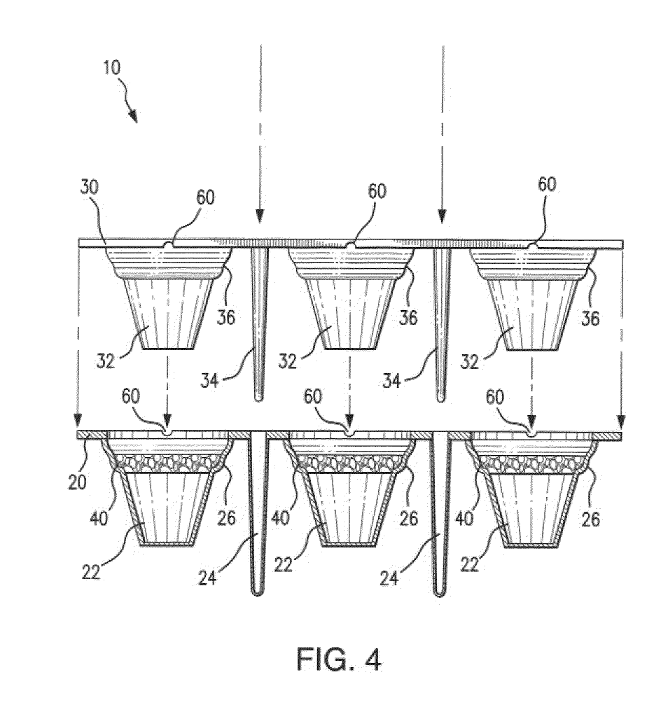

Dough 40 is inserted into the female mold 22. In a preferred embodiment, the dough 40 is suspended in the female mold 22 by annular ridge 26 as shown in FIG. 4. This is helpful because it keeps the dough 40 evenly spread in the female mold 22. The top sheet 30 is then lowered onto the bottom sheet 20. First, the male guiding tubes 34 enter the female guiding tubes 24 to provide alignment. Then, the male molds 32 enter the female molds 22. This causes the dough 40 to be pressed down into the bottom of female mold 22. When this occurs, the sheets 20 and 30 are secured together using a number of clamps 50 in order to prevent the sheets from separating during baking.

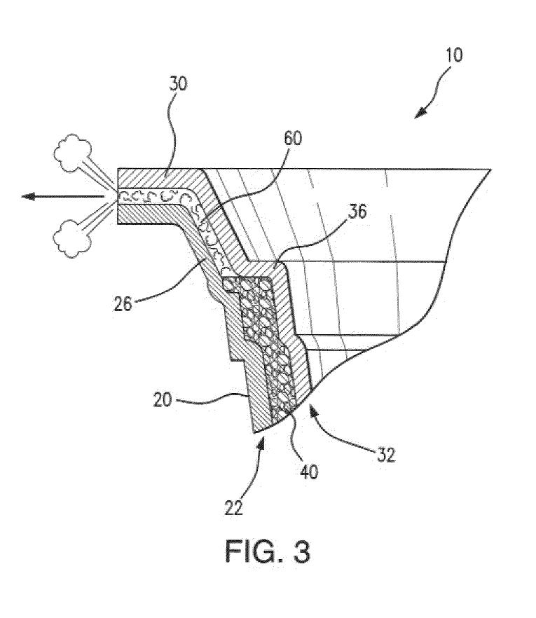

After the sheet 20 and 30 are secured together using clamps 50, the dough 40 is baked in order to produce a final product (e.g. an edible bread cup). During the baking, the dough 40 will expand upwardly through the void present between female mold 22 and male mold 32. This will pressure the air in this region and a mechanism must be in place so that this air may escape. In a first preferred embodiment of the present invention illustrated in FIGS. 1-4, air escapes during baking through canal grooves 60. Canal grooves 60 are formed through semi-cylindrical grooves built into the top sheet 30 and bottom sheet 20. These are aligned when the sheets 20 and 30 are brought together, which then form the canal grooves 60. As shown in FIG. 3, air is pressed upward by the expanding dough 40 and escapes through the canal groove 60 located at the upper region of the void between molds 22 and 32.

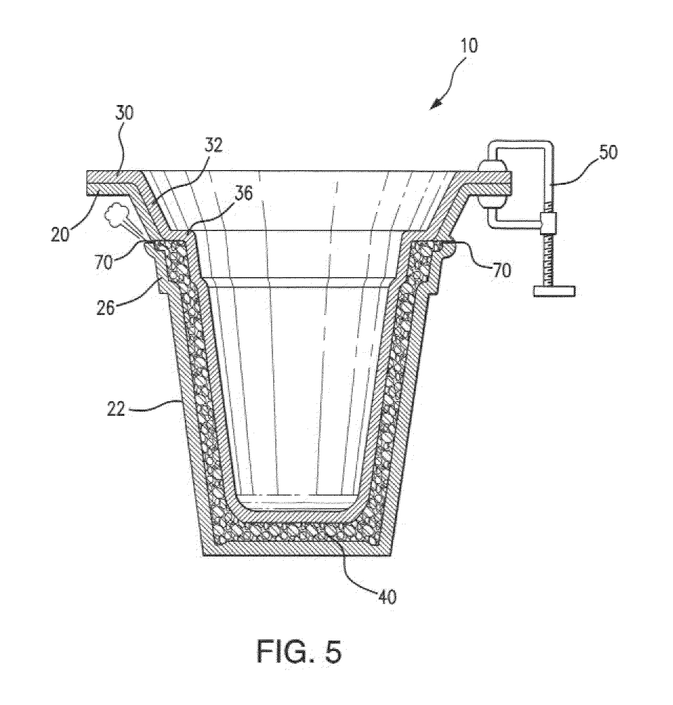

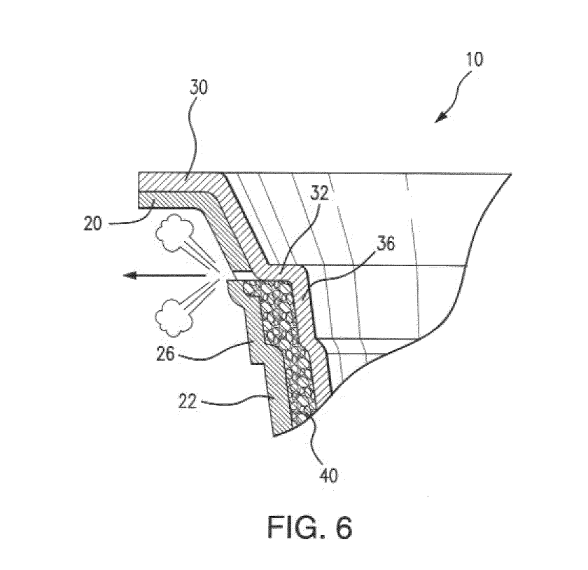

In a second preferred embodiment shown in FIGS. 5-6, air escapes through air release pinholes 70 which are built into the female mold 22. Any number of air release pinholes 70 may be created along the upper outer edge of the female mold 22. The pinholes 70 may be made whatever size is appropriate for releasing the air during baking.

After the baking is complete, clamps 50 are released and the sheets 20 and 30 are separated. The finished cups made from dough 40 are then removed and used for their intended purposes.

While the present invention has been shown and described in accordance with several preferred and practical embodiments, it is recognized that departures from the instant disclosure are fully contemplated within the spirit and scope of the invention.

What is claimed is:

1. An edible bread cup for holding one or more food products comprising:
a single piece of molded baked dough having an annular outer side wall extending between a bottom wall and an annular top rim surrounding an open top, and said outer wall and bottom wall surrounding an interior chamber for receiving and holding the one or more food products therein, said single piece of molded baked dough having a crusted outer layer and crusted inner layer for preventing moisture from the one or more food products from leaking through said edible bread cup.

2. A method of producing an edible bread cup for holding one or more food products, said method comprising the steps of:
securing a unit of dough on an annular ridge of a female cup mold, said female cup mold being on a female mold sheet having a plurality of female cup molds;
lowering a male mold sheet onto said female molding sheet, said male molding sheet having a plurality of male cup molds sized slightly smaller than said plurality of female cup molds, and said plurality of male cup molds being guided into said plurality of female cup molds, thereby pressing said unit of dough into said female mold cup and leaving a gap between an inner surface of said plurality of female cup molds and an outer surface of said plurality of male cup molds;
securing together said female mold sheet and said male mold sheet using a securing mechanism;
baking said female mold sheet and said male mold sheet, thereby allowing the unit of dough to expand upwardly within said gap between the inner surface of said plurality of female cup molds and the outer surface of said plurality of male cup molds, and thereby producing a single piece of molded baked dough having an annular outer side wall extending between a bottom wall and an annular top rim, said single piece of molded baked dough having a crusted outer layer and a crusted inner layer for preventing moisture from the one or more food products from leaking through said edible bread cup; and
allowing air to escape between said male mold sheet and said female mold sheet as the unit of dough expands upwardly during said step of baking.

3. The method as recited in claim 2, wherein said securing mechanism is a clamp mechanism.
